(19) United States
(12) Patent Application Publication
(10) Pub. No.: US 2026/0296685 A1
(43) Pub. Date: Oct. 1, 2026

(54) CENTRIFUGAL FAN PROPULSION SYSTEMS AND METHODS FOR AN AERIAL VEHICLE

(71) Applicant: SACUBA PTY LTD, Endeavour Hills VIC (AU)

(72) Inventor: William LUO, Endeavour Hills VIC (AU)

(21) Appl. No.: 19/574,610

(22) Filed: Mar. 23, 2026

(30) Foreign Application Priority Data
Mar. 24, 2025 (AU) 2025900956
May 20, 2025 (AU) 2025901935

(51) Int. Cl. B64U 10/13; B64C 27/82; B64U 30/26

(52) U.S. Cl. CPC B64U 10/13; B64C 27/82; B64U 30/26; B64C 2027/8227

(57) ABSTRACT

The present disclosure is directed to vehicles and in particular, aerial vehicles. A vehicle comprising a housing supporting at least one impeller substantially axially positioned within the housing, the housing comprising a perimeter and including a plurality of air channels to direct air from the impeller to outlet vents at or proximal to the perimeter is provided.

Other embodiments include vehicles with a first and second, or primary and secondary centrifugal fans.

### CROSS-REFERENCE TO RELATED APPLICATIONS

This application claims the benefit of Australian Patent Application No. 2025900956 filed Mar. 24, 2025, and Australian Patent Application No. 2025901935 filed May 20, 2025, the entire contents of which are incorporated herein by reference in their entireties.

### FIELD OF THE INVENTION

Disclosed are centrifugal fan propulsion systems and methods for an aerial vehicle, and more particularly, manners and methods in which to generate lift and movement for flying using the disclosed centrifugal fan propulsion systems and methods.

### BACKGROUND

Aerial vehicles have evolved so that they are useful in many situations. Depending on its use, a vehicle may have a particular shape. For example, a consumer vehicle may take the shape of saucer. Having a saucer or conical shape, its impeller(s) may be positioned internally rather than outside its hull.

Controlling the movement of such vehicles is a challenge and previous aerial vehicles have used complex thrust vectoring systems to change the direction of thrust. One example of such a system is U.S. Pat. No. 11,332,241 which discloses a thrust vectoring system to change the direction of thrust, which is by either rotating the whole centrifugal fan housing relative to the pivoted fuselage, or rotating the nozzle relative to the centrifugal fan in order to change the thrust direction. This method would be a much slower response comparing to the disclosed embodiments.

In other prior art documents, such as CN101284570, the impeller is only used for movement in a single direction, i.e. lift, and directional control is provided by other systems.

There is a need to address the above, and/or at least provide a useful alternative.

### SUMMARY

Disclosed is a vehicle comprising a housing supporting at least one impeller substantially axially positioned within the housing, the housing comprising a perimeter and including a plurality of air channels to direct air from the impeller to outlet vents at or proximal to the perimeter.

The housing may have a substantially conical or spherical shape. Preferably, the air channels are at the housing perimeter.

The outlet vents may be proximal to the housing perimeter.

The housing may also include gates proximal to the air channels for opening to allow airflow therethrough and for closing the channels to restrict airflow and at least one motor configured to operate one or more gates.

Also disclosed is a vehicle wherein the motor is a servomotor.

Additionally disclosed is a vehicle including a second impeller. Moreover, disclosed is a vehicle wherein the second impeller is supported by the housing and wherein the housing further includes a second plurality of air channels and second gates proximal to the second impeller.

Furthermore, disclosed is a vehicle wherein the gate is configured to slide open and closed.

Also disclosed is a vehicle wherein the gate is a channel separator configured to pivot.

Additionally disclosed is a e vehicle that is configured for terrestrial movement.

Disclosed is method of providing a vehicle including a housing supporting at least one impeller substantially axially positioned within the housing, the housing comprising a perimeter, the method including providing a plurality of air channels to direct air from the impeller to outlet vents at or proximal to the perimeter.

The housing may have a substantially conical or spherical shape. Preferably, the outlet vents are proximal to the housing perimeter.

The housing may also include gates proximal to the air channels for opening to allow airflow therethrough and for closing the channels to restrict airflow and providing at least one motor configured to operate one or more gates.

Also disclosed is a method wherein the motor is a servomotor.

Additionally disclosed is a method including a second impeller.

Moreover, disclosed is a method of wherein the second impeller is supported by the housing and wherein the housing further includes a second plurality of air channels and second gates proximal to the second impeller.

Furthermore, disclosed is a vehicle wherein the gate is configured to slide open and closed.

Also disclosed is a method wherein the gate is a channel separator configured to pivot.

Additionally disclosed is a method wherein the vehicle is configured for terrestrial movement.

Also, disclosed herein is a vehicle comprising:
a main housing supporting a first centrifugal fan substantially axially positioned within the housing, the housing comprising a perimeter and including a plurality of air channels to direct air from the first centrifugal fan to one or more outlet vents at or proximal to the perimeter,
a housing nozzle extending from the perimeter of the main housing and defining a rearward outlet vent, and
a second centrifugal fan mounted to the housing nozzle and adapted to counteract a torque of the first centrifugal fan on the vehicle.

The second centrifugal fan may be positioned such that air flow through the outlet of the fan is oriented tangentially to the first centrifugal fan housing such that the thrust direction of the second centrifugal fan can counteract the torque of the first centrifugal fan on the vehicle.

The second centrifugal fan may be smaller than the first centrifugal fan.

Further disclosed is a vehicle comprising:
a housing supporting a primary centrifugal fan substantially axially positioned within the housing, the housing comprising a perimeter and including a plurality of air channels to direct air from the primary centrifugal fan to one or more outlet vents at or proximal to the perimeter,
a plurality of secondary centrifugal fans mounted to an outer surface of the housing and adapted to counteract a torque of the primary centrifugal fan on the vehicle, in use. Each secondary centrifugal fan may be smaller than the primary centrifugal fan.

The vehicle may further comprise a plurality of secondary fan housings for supporting the secondary axial fans axially within the secondary fan housing, the secondary fan housing having a nozzle defining an outlet.

The outlet airflow of each secondary centrifugal fan may be adapted to counteract the pitching/rolling and yawing torque caused by the primary centrifugal fan.

In yet another embodiment, there is disclosed a vehicle comprising:
a housing supporting at least one impeller substantially axially positioned within the housing;
an inlet at the top of the housing and an outlet at the bottom of the housing together defining an air channel;
a gate operably connected to the impeller and located proximal to the outlet;
at least one motor operably connected to the gate and configured to move the at least one gate wherein horizontal movement of the gate changes the shape of the air channel, causing tilting of the vehicle in use.

The vehicle may further comprise a cylindrical or conical housing.

The at least one motor may be connected to the gate via a slot and pin arrangement.

### BRIEF DESCRIPTION OF THE DRAWINGS

In order that the invention may be more easily understood, an embodiment will now be described, by way of example only, with reference to the accompanying drawings, in which: FIGS. 1A and 1B depict the aerial vehicle;

FIG. 2 depicts a side view of an interior slice of the disclosed vehicle having a first propulsion system and a second propulsion system;

FIG. 3A is a top-down view of the disclosed conical housing with a first propulsion system;

FIG. 3B is a cross-sectional elevation view of the conical housing of FIG. 3A;

FIGS. 4A and 4B depict additional redirection valves of the first propulsion system;

FIGS. 5A and 5B depict the second propulsion system and balanced airflow;

FIGS. 6A and 6B depict the second propulsion system and unbalanced airflow;

FIGS. 7A and 7B depict pivoting vanes that are fixed to the housing at an inflection point;

FIG. 8 depicts rotated pivoting vanes and channels of the first propulsion system;

FIGS. 9A, 9B and 9C depict an example aerial vehicle with a single propulsion system variation on the conical housing

FIG. 10A depicts an example of propulsion system with cylindrical housing;

FIG. 10B depicts a bottom view of the disclosed propulsion system having a single gate and servomotors;

FIGS. 11A, 11B, 12 and 13 depict the disclosed propulsion system with shifted gate and unbalanced airflow;

FIG. 14 depicts an alternative embodiment of the aerial vehicle with a first and second centrifugal fan;

FIG. 15 depicts a sectional view of FIG. 14;

FIG. 16 depicts a perspective view of another embodiment of the aerial vehicle with a primary centrifugal fan and secondary centrifugal fans;

FIG. 17 shows a side view of a secondary centrifugal fan;

FIG. 18 shows a bottom view of the embodiment of FIG. 16;

FIG. 19 shows a bottom view of the embodiment of FIG. 17 in another example of operation;

FIG. 20 shows a perspective view of FIG. 19;

FIG. 21 shows a perspective view of an example inlet, and

FIG. 22 shows a side sectional view of FIG. 21.

### DETAILED DESCRIPTION

Disclosed is an aerial vehicle 100 having a substantially conical housing. FIGS. 1A and 1B depict the aerial vehicle with the substantially conical housing 101 on its top portion. The lower portion(s) of the vehicle may take any suitable shape. The conical housing may include conical surfaces that are curved, for example, to give the vehicle a saucer shape. It is understood that the conical housing includes any similar profiles. At the perimeter 103 of the conical housing 101, there is shown air channels 121 that will be discussed in more detail below.

There are at least two embodiments discussed below. A first embodiment may include a double propulsion system, the first propulsion system for radial propulsion to deliver horizontal thrust and the second propulsion system for axial propulsion to deliver vertical thrust. A second embodiment may include a single propulsion system with radial and axial propulsion to deliver both horizontal and vertical thrust. In this way, the at least two embodiments may be capable of hovering, flying in high speed and driving on land. In this way, the disclosed systems and methods may provide for manned or unmanned land or aerial vehicles for hobbies or transport.

A first advantage as well as being able to perform vertical take off and landings, the first embodiment may potentially fly faster than helicopters as the propelling force may fully shift from vertical to horizontal by controlling the air outlet vents, and still able to utilise air foil shaped body to achieve horizontal lift efficiency whereas helicopter cannot use air foil wing to achieve lift as it may block the air flowing downward.

A second advantage may be the internal rotating blades design. With impeller vanes stored inside the casing, this provides safeguard against contact with people or obstacles.

Third advantage is the ability to convert from aerial vehicle to land vehicle by continuing to use the impeller to propel forward without requiring power to the wheels to drive. The pair of horizontal rotors may allow the vehicle to yaw or turn, and with no external propellers to pose risk in land driving.

The prior art of centrifugal fan propulsions, whether using type 1 (centrifugal fan) or type 2 (using additional wind scooper) require several propulsion systems fitted to an aircraft for vertical take on, which would be obviously possible by varying the power difference between the systems to balance on air.

In same way as helicopter with single rotor is more efficient than multiple rotors as typical vehicles, the same goes for centrifugal fan propulsion rotors. That is, a single large impeller rotor, or pair of rotors lined up along the same rotational axis is much more efficient than multiple impeller rotors spread out at different rotational axis. To make it possible to hover using single line of rotors would require new manoeuvring features added to the propulsion systems as disclosed below, which involves controlling the rotation in three (3) axis—yaw, pitch and roll.

There may be differences in propellers and impellers or centrifugal fans. Traditional propellers draw air directly from front to back of the propeller. Whereas in the disclosed impeller propulsion or centrifugal fan technology, incoming air is impelled outward from the rotational plane firstly, then air is exited through an opened air outlet at the side of the casing. This may cause an opposite force on the system for propulsion in the direction perpendicular to the rotating plane of the impeller. Or in another possible way, the impellors drive the air outward along the radius until it reaches the casing. The casing is designed with internal shape such that the air that flow towards it would eventually be deflected downward. Then the air is exited from the opening of the housing, which may either be the bottom or side of the housing. This may cause the system and vehicle to propel in the opposite direction of the deflected air, which is same as the axial direction of the rotating impeller.

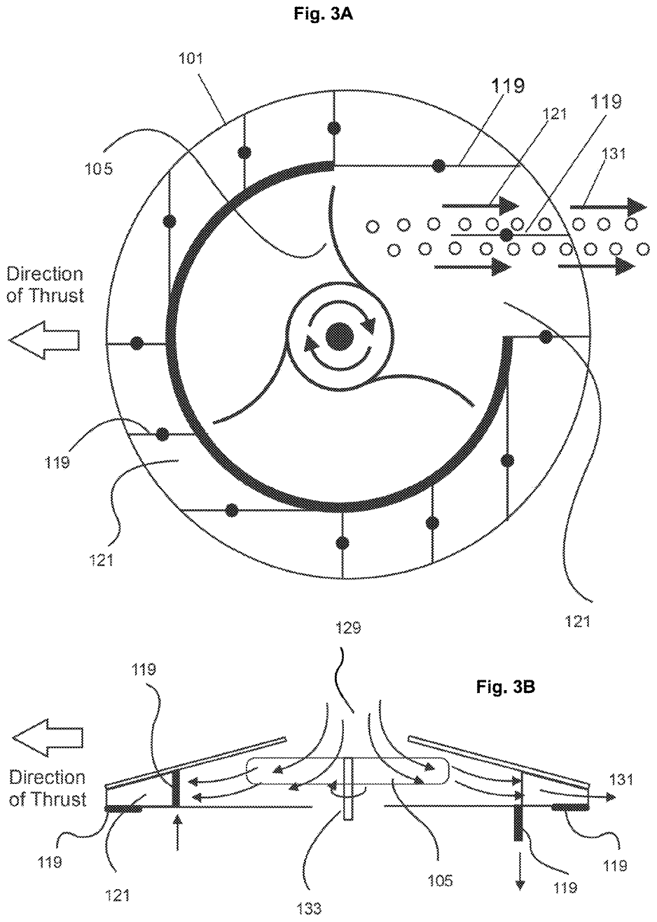

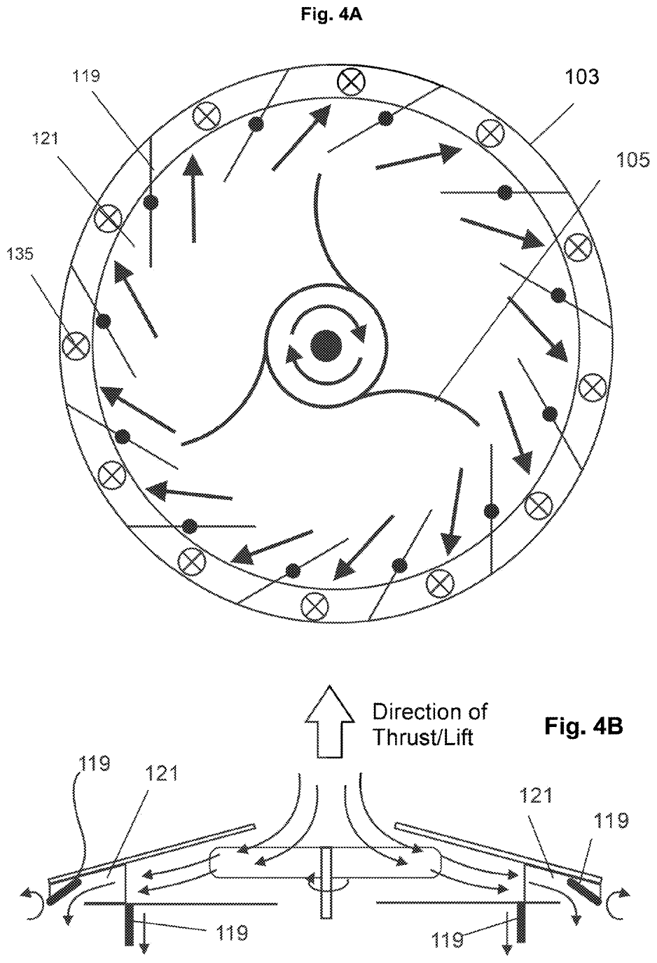

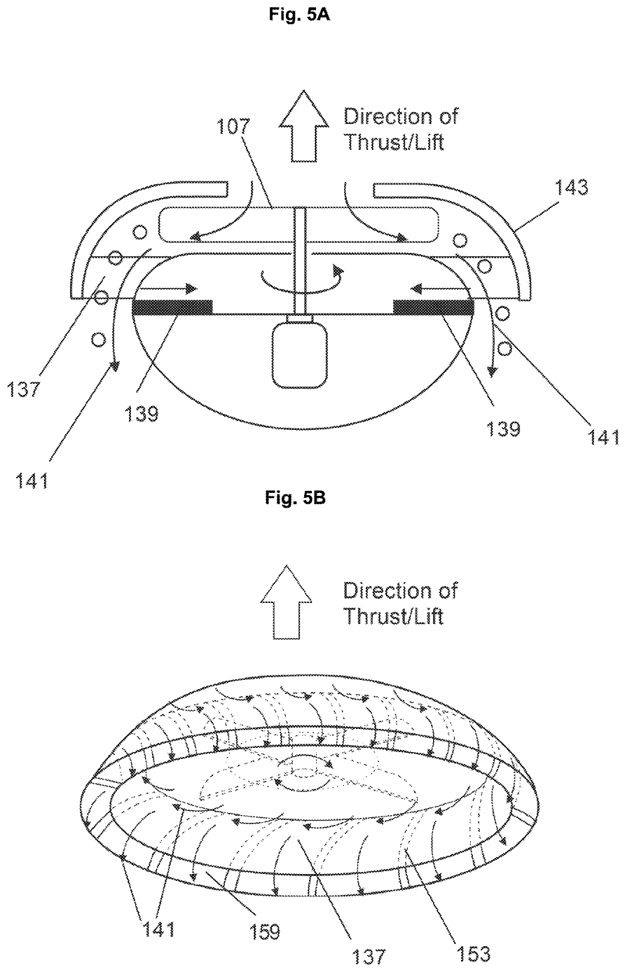

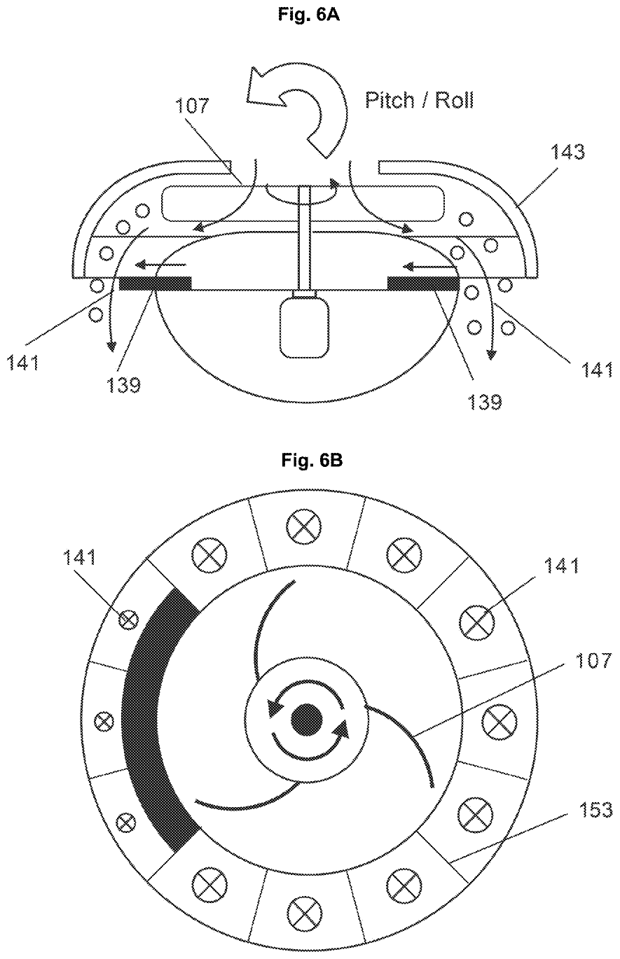

There are generally two (2) types of housing shapes that may effectively deflect the air. A straight diagonal edge deflection using cone shape casing as shown in cross-sectional FIGS. 3B and 4B discussed below, or curved edge deflection using a spherical shaped casing as shown in FIGS. 5A and 6 as discussed below. Both casing shapes may deflect the incoming air downward. Accordingly, the lower outer rim of the casing may be opened to allow air to exit.

### Main Components

### Impeller:

Any type of impeller shapes that are known for centrifugal fans and compressor to accelerate air radially outward using rotating blades may also work for the present propulsion purposes; larger impeller are more efficient and therefore, the present invention includes a relatively large impeller to the overall size of the vehicle to benefit from efficiency of a larger scale.

### Air Inlet Eye:

An air inlet eye may be located at or proximal to the central axis of rotation of the impellor, either on the top or bottom side. The air inlet eye may include channels to reduce turbulence in drawing air (similar to compressor). Both propulsion systems may share the same air inlet eye, which may either be located at the top of the vehicle as shown in FIG. 1 or may be located at the bottom (which is not shown in FIG. 1).

### Air Outlet Vents:

Air outlet vents are the end points of the air channels where the air is exited from the vehicle. The outlet vents are lined up in annular shape and may be proximal to the vehicle perimeter for effective controlling, manoeuvre and balancing of the vehicle.

### Air Channels and Gates:

As the air is swept out from the impeller, the direction of air stream is spread out through all angles. Any surface of the propulsion system that the impelled air pass through before leaving through the outlet can contribute to part of the air channel. The design of the air channel has direct relation to the direction and power of propulsion. Multiple air channels separated by vanes can provides efficiency advantage over single channel for axial propulsion. In addition, each channel can have separate gate to control air flow through it, thereby providing manoeuvrability to the vehicle as to be explained in detail.

### Housing With Internal Air Deflecting Shape:

Using a cone or spherical shape casing as part of the channel to deflect air downward may provide thrust in the direction of the axis of rotation of the impeller, which may then propel the disclosed vehicle upward for lift.

### Power Supply:

A power supply may be any type of conventional power source such as battery and motor, combustion engine, hydro jet, etc.

### Control System:

A control system may use a gyroscope as do drones to control the rotor power and opening of valves. A similar control system used in drone technology may be applied to control flight for the disclosed vehicle. Instead of controlling the motor power to achieve desired 3-axis rotation position and elevation in drones, the disclosed vehicle may achieve this by using this control system to control the opening of the valves, vane angles, as well as the motor power. The amount of opening of valves may be precisely set at very small increments, which may be achieved using servo motors or using hydraulic system as those used in controlling aircraft flaps. The control system may provide both automatic flight control to maintain stability on air, or for manual control to manoeuvre.

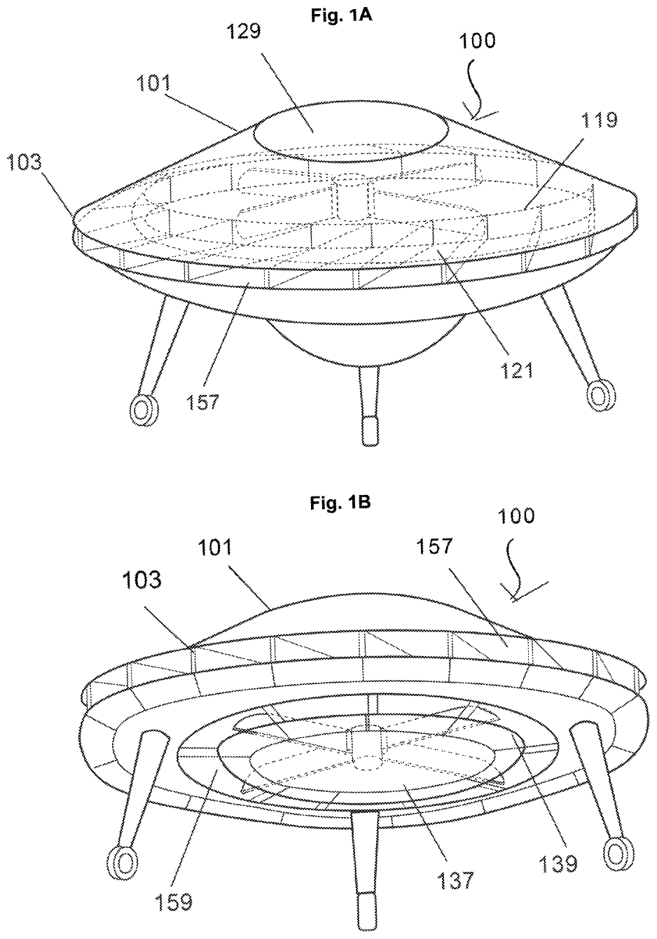

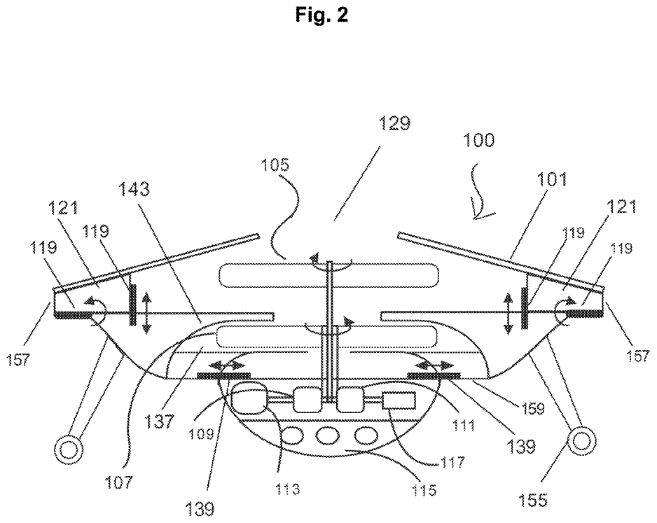

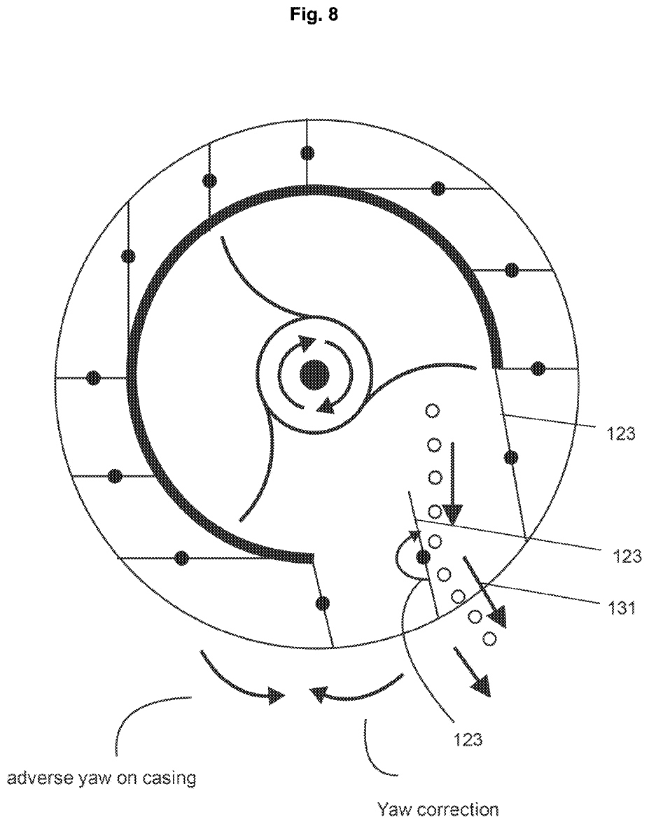

FIG. 2 depicts a side view of an interior slice of the disclosed vehicle 100, having a first propulsion system and second propulsion system. Depicted is a first propulsion system 105. The first propulsion system acts centrifugally and may provide radial propulsion to deliver horizontal thrust. An impeller, or impellor, is a driven rotor used to increase the pressure and flow of a fluid. The impeller 105 may operate without the second propulsion system or impeller 107 may be provided depending upon providing stabilising configurations (discussed below with respect to FIG. 8).

The second propulsion system 107 can also act centrifugally and may provide axial propulsion to deliver vertical thrust or lift. The impeller rotor 105 of the first propulsion system may rotate in the opposite direction to the impeller rotor 107 in the second propulsion system to provide stability for the fuselage from adverse yaw. That is, the impeller first propulsion system 105 rotating in the opposite direction to the impeller of the second propulsion system 107, so that the fuselage may avoid adverse yaw. Yawing may be achieved by varying the power difference between one rotor spinning clockwise to the other rotor spinning anticlockwise, which is the same way as how vehicle rotates. It is understood that various mechanisms may provide stability for the fuselage to avoid adverse yaw.

The lower portion of the vehicle may include a motor/engine 109 for first impeller 105 and a second motor/engine 111 for second impeller 107. Furthermore, a battery/fuel supply 113, a fuselage 115 and a control system 117 are depicted in FIG. 2.

While this discussion refers to the vehicle 100, the depicted vehicle 100 may include devices for terrestrial travel 129 such as wheels or tracks. The inclusion of devices for terrestrial travel 129 deviate from a typical vehicle configuration such that the presently depicted vehicle may be referred to as a flying vehicle or other suitable name.

The channels 121 depicted at the perimeter 103 of the conical housing 101 are shown proximal to sliding gates 119, the arrows indicating the direction of the sliding gates 119. It is understood that the configuration of the channels and the gates which may also be referred to as valves, be they sliding gates or pivoting gates includes all suitable configurations wherein the gates may be both sliding and pivoting and may include any suitable manner in which to open them by varying degrees and in which to close them by varying degrees. The gates or valves may for example, open radially. It is understood that any suitable manner in which to allow air to pass through the channels or stop air from passing through the channels is within the scope of this discussion.

The motors 109 and 111 to control the impellers 105 and 107 are depicted in FIG. 2. Not shown are motors to control the gates 119 proximal to the channels 121. The motors may be simple motors or may be servomotors or other actuators, depending upon the desired control of the gates 119. The control system 117 may include various sensors and software to respond to current conditions in which the disclosed vehicle 100 is flying or moving terrestrially.

To convert from aerial vehicle to land vehicle, the valves 119 of the first propulsion systems 105 are opened, whereas the valves 139 of second propulsion system 107 are closed so there is no vertical lift. The disclosed vehicle 100 may then drive on land and make turns by varying the power between the impellers 105 and 107.

Air currents for example are sensed by sensors. Where there is a lift, or down draft, or cross currents, sensors may detect the ambient air currents in real time and the control system 117 may adjust the gates 119 according to that information. The control system 117 may also be manipulated by a user having control of the direction in which the vehicle is moving. It is understood that the control system may be in communication with, for example, multiple sensors and at least one user's control.

FIG. 3A is a top-down view of the disclosed conical housing with a first propulsion system; depicting a first impeller 105. There is text above an arrow indicating the “direction of thrust” being to the left of FIG. 3A. That is, the direction of thrust is the direction in which the vehicle 100 would be moving. In that case, for example, the channels may be grouped together in quadrants. A quadrant in the right top portion of FIG. 3A may be formed and opened to allow airflow that moves past the impeller 105 to exit from that quadrant.

Similarly shown in FIG. 3B, which depicts a side view cut-away of the disclosed vehicle 100, the direction of thrust is similar to that shown in FIG. 3A, to the left of the Fig .. The direction of the airflow 131 is to the right because the gate 119 next to the arrow is open.

The first generating propulsion system 105 may control the horizontal speed and direction. Given that the impeller rotates clockwise as in FIG. 3A, only the valves 119 of the air outlet vents 121 at the top right corner are opened, so that the swept air from the impeller 105 may escape directly out to the back of the housing 101. As discussed above, this would then generate thrust to the left side of FIG. 3A. Accordingly, opening the bottom right corner gates or valves 119 would cause thrust to the right. Opening bottom right gates or valves 119 would cause thrust to the top side and opening top left valves 119 would cause thrust to the bottom side of FIG. 3A.

The control of air flowing out from the air outlet vents may be controlled by separate valves 119 fitted to air outlet or channel 121. According to testing, it may be generalized that the propulsion or thrust is related to the air outlet vent, that is, the direction of propulsion may be opposite the direction of the air flowing out from the opened air vent of the vehicle.

As mentioned above, sensors (not shown) may be utilised to provide information to the control system 117. The control system 117 may include a gyroscope to keep the vehicle balanced and manoeuvrable in air. Instead of varying the power supply to one or both of the propeller motors 105 and/or 107 to manoeuvre, opening of the gates or valves 119 of a respective air channel or outlet vent 121 to manoeuvre in similar way as airplane uses flaps, such as using servo motors, may provide improved manoeuvrability. That is, by utilizing a closed-loop control systems 117 with feedback precise adjustments may be provided.

Referring to FIGS. 4A and 4B, additional redirection gates may be added to the first propulsion system 105 (and to the second propulsion system 107) shown in FIGS. 3A and 3B for downward airflow. Therefore, the first propulsion system 105 may be able to provide centrifugal propulsion.

FIG. 4A depicts a downward view cut through the first impeller 105. The horizontal thrust generating propulsion system may also be used for generating vertical lift by opening all valves of air outlet vents as shown in FIG. 4. Air may be deflected down by the surface of the redirectional gates 119 that diverts the air stream downward as indicated by the circles with the “x” 135. Accordingly, the first propulsion system 105 along with channels opened downward 135 may generate combined lift, for example, during take-off.

More particularly, in FIGS. 4A and 4B, it is shown that instead of including the second propulsion system 107, the channels 121 and their respective gates or valves 119 may be used to provide the lift that the second propulsion system 107 may provide. Gates 119 are shown to slide open to allow airflow into the channel 121 and gates 119 are shown to pivot open to allow airflow through the channel in the downward direction 135. In this way the direction of the thrust or lift is in the upward direction.

FIGS. 5A and 5B depict the second propulsion system for axial thrust to deliver vertical propulsion or hover. FIG. 5A depicts a vertical cutaway view of the lower portion of the disclosed vehicle 100. FIG. 5B depicts a 3D view of the channel and impeller only for the lower portion of the disclosed vehicle 100. Briefly referring to FIG. 1B and FIG. 2, there is shown perimeter 103, channels 137, outlet vent 159 and gates or valves 139 that are proximal to the second propulsion system 107 which is positioned within the interior 143 of the conical housing 101. In FIGS. 5A and 5B, the second propulsion system 107 is shown within the interior 143 of the conical housing 101.

FIG. 5A shows an upward direction of the thrust or lift wherein the gates or valves 139 are opened to let airflow 141 move in the downward direction. FIG. 5B shows that airflow 141 may be created by the movement of the blades of the impeller 107. The impelled air 141 initially flows in vortex motion around the channel formed by the outer and inner spherical layers that cover the impeller. Then the air enters the channel vanes 153 that separate into multiple channels 137. These vanes are curved in profile, such that the air vortex is guided to flow axially downward to the outlet vent 159 as shown by the downward airflow 141. As the surface of the vanes faces against the circular direction, any tangential velocity component of the air vortex is converted to have an axial velocity component. This maximises the vertical thrust level by utilising the full vector of the air velocity.

As shown in FIG. 5B, the U shape curved channels vanes 153 are effective for scooping air stream with low speed. For a high-speed spinning impeller, the channel vanes may be replaced with airfoil curved vanes near the annular outlet to improve efficiency in gaining upward lift. Since the air stream swirls out at about 30 degrees downward without the channel vanes, the optimal angle of attack of the airfoil for channel vanes would be 60 degrees from the rotational plane of the impeller. This can cause the air to be deflected downward with maximum lift gain.

FIGS. 6a and 6b depict the second propulsion system with unbalanced airflow, for example, for pitching or rolling. In this example, the second impeller 107 may push airflow through the opposite channels in varying amounts due to the varying openings of the gates 139. That is, for pitching, this may be achieved by allowing the back valves on the right side of FIG. 6a to be opened wider than the front valves of the air vents as shown on the left side of FIG. 6A. For rolling, the left or right valves may be opened wider than the right or left valves. Depicted in FIG. 6B by larger circles with an “x” on the right side of FIG. 6B to depict greater airflow and smaller circles with an “x” on the left side of FIG. 6B to depict smaller airflow.

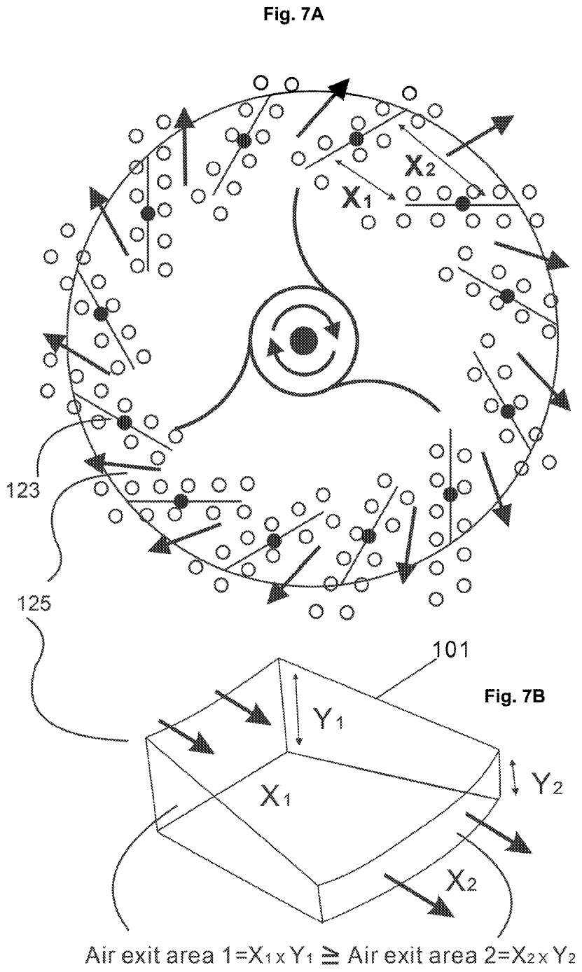

FIGS. 7A and 7B depict pivoting vanes that are fixed to the housing 101 at an inflection point and pivot around that inflection point either freely or by a motor. The air exiting channels may include these pivoting vanes attached to the housing 101 so the air may travel out in several channels 125 separated by the pivoting vanes 123 to maintain or increase the air exiting speed. FIG. 7A shows pivoting vanes 123 of the channels 125 that are lined up to the same direction of the air flowing out. Referring to FIG. 7b, as radius increases, the surface area of the fixed channel 125 may increase. As such, the depicted air channels 125 accelerate airflow by a reduction in surface area by reducing the height of the air outlet further from the centre point of the conical housing 101 to compensate for the increasing horizontal distance. The depicted air channels 125 may be positioned interior to the channels depicted in other Figures of this disclosure.

Channels 125 may reduce air turbulence by controlling the air to flow through channel 125, thereby allowing air to flow out quicker. The pivoting vanes 123 may function in a manner similar to airplane tail wings for stabilizing flight and may avoid adverse yaw and pitching to keep it flying in straight path. FIG. 8 depicts rotated pivoting vanes 123 to deflect the air flowing out, which may result in clockwise yaw of the casing to cancel out the adverse yaw. The pivoting vanes 123 and their channels 125 may make it possible to only use a single propulsion system 105 with no counter spinning rotor 107 that may keep stable the vehicle 100 stable.

Referring to FIG. 8, by using adjustable/rotatable vanes on the air exiting channels yaw on the vehicle 100 may result which may then cancel out the adverse yaw. The amount of yaw torque may depend on the angle of vane makes with the linearly moving air along an exit channel. Therefore, the adjustable vanes 123 act like the airplane rudder flaps for adjusting the yaw. This may make it possible to only use a single propulsion system with no counter spinning rotor required to keep stable, thereby maximizing the efficiency of the vehicle 101.

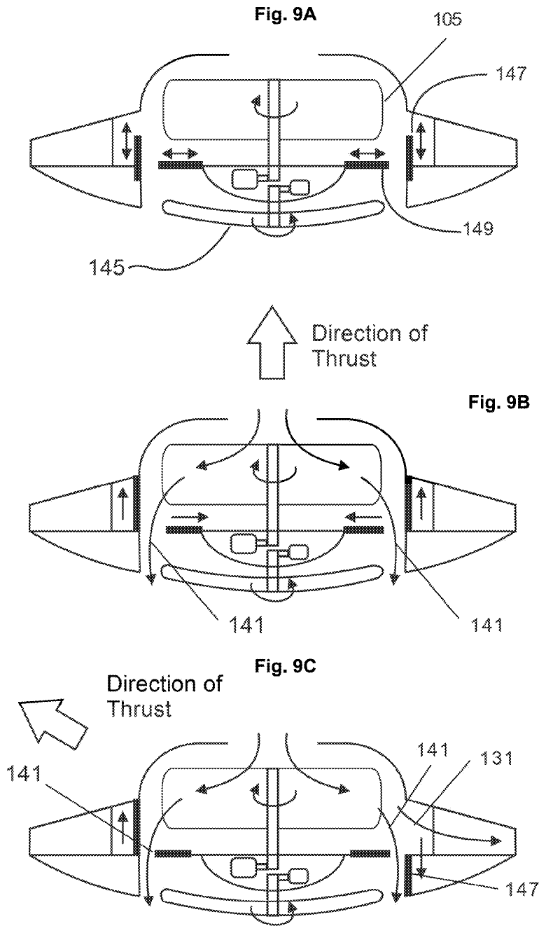

FIGS. 9A, 9B and 9C depict an aerial vehicle with a single propulsion system and with a variation on the conical housing 101. A side-view slice of the housing 101 shows that the conical profile is truncated toward the centre of the vehicle 100. As mentioned above, it is understood that any substantially conical housing profile is within the scope of this discussion, including, for example, curvature and slope variations.

As discussed above, utilising only the first propulsion system to provide both horizontal and vertical thrust by using two (2) sets of valves to direct the air flow is within the scope of this discussion. Alternatively, the second propulsion system may be replaced by a counter rotating flywheel 145 for stability and yawing control purpose only as shown in FIGS. 9A, 9B and 9C.

To generate lift and hover on air, all the vertical valves 149 may be closed and horizontal valves 147 may be opened, so the air is directed to flow downward. The flywheel 145 may counter spin to cancel the adverse yaw and increase stability. To generate both lift and forward thrust, the horizontal valves 147 may be opened in half and vertical valves 149 may be opened only on one side, as some of the lift force may be delivered by the top curved sphere and cone shape of housing 101. The adverse yaw may be cancelled by the rotated vanes in the exiting channels as shown in FIG. 8, so the rotation of the flywheel 145 may be slowed down or turned off during flight to reduce energy waste.

FIG. 9B depicts the direction of thrust being upward wherein to achieve the upward thrust the airflow 131 may be directed downward. FIG. 9C depicts the direction of thrust to be to the left of the figure. FIG. 9C further depicts the vertical valve 147 to be slide downward to let the airflow 131 to move to the right of the FIG. 9C.

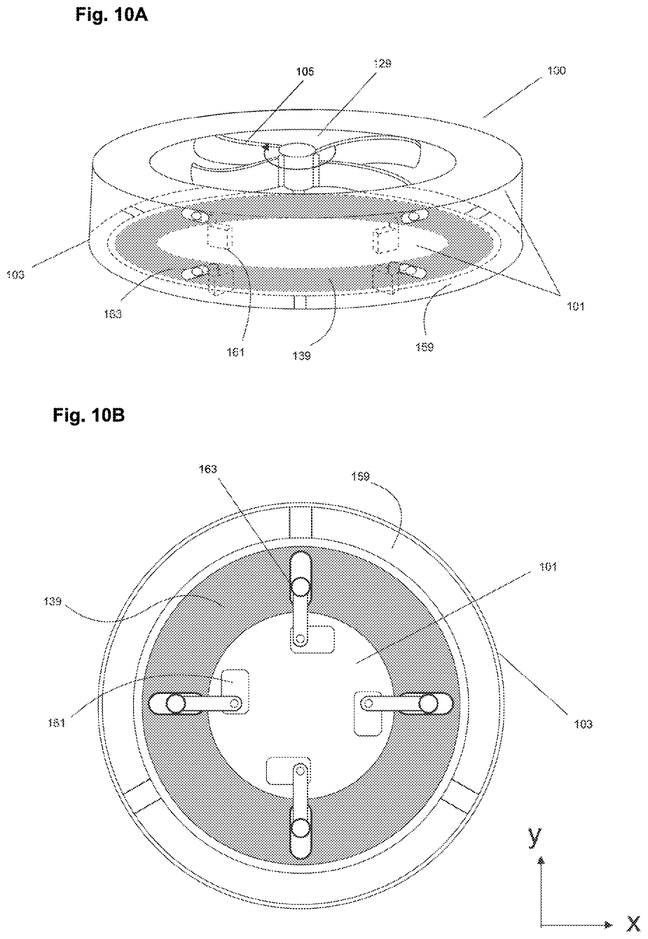

FIG. 10A shows an embodiment of an aerial vehicle 100 using axial centrifugal fan propulsion system and controlled by a single gate 139 capable of causing the vehicle to rotate. The aerial vehicle comprises a housing 101 supporting at least one impeller 105 substantially axially positioned within the housing 101, an inlet 129 at the top of the housing 101 and an outlet 159 at the bottom of the housing 101 together defining an air channel, a gate 139 operably connected to the impeller 105 and located proximal to the outlet 139 and at least one motor 161 operably connected to the gate. The at least one motor 161 is configured to move the at least one gate wherein horizontal movement of the gate 139 changes the shape of the air channel, causing tilting or rotation of the aerial vehicle 100, in use.

The vehicle comprises a housing 101 in a cylindrical shape with air inlet 129 located at the top of the cylindrical housing 101, and lower air outlet vent 159 in a ring shape at the bottom of the cylindrical housing 101 and proximal to the perimeter 103 of the housing of the vehicle. With no air channel within the housing, the impelled air can be swirled down by the increased air pressure and pass out down through the air outlet 159 due to lower pressure in the atmosphere. A cylindrical shaped housing can be more efficient in generating thrust than other housing shapes.

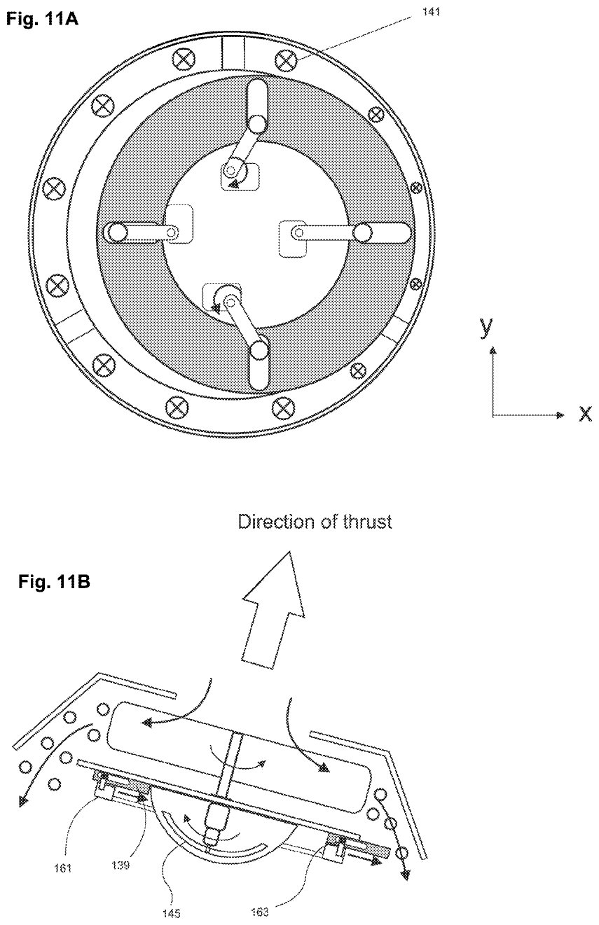

With thrust generated by impeller 105, any adverse yaw on the vehicle can be cancelled by a reversely rotating element or flywheel 145 with axis of rotation parallel to the axis of rotation of the impeller as shown in FIG. 11B.

As shown in FIGS. 10A and 10B, proximal to the ring-shaped air outlet 159 is also a ring-shaped gate 139 as shown with grey background to distinguish from the housing. The gate 139 is manipulated by a plurality of servomotors 161. This gate 139 is connected via slot and pin arrangement 163 to the cranks of 4 servomotors 161 fitted at equidistant positions at the bottom of the housing 101.

Each pair of oppositely positioned servomotors 161 are synchronized to operate in opposite direction of rotation in order to shift the gate 139 with balanced force. The front and back servomotors 161 can shift the gate to the left or right position, whereas the left and right servomotors 161 can shift the gate to the front or back.

In FIG. 10 b, all servomotors 161 are set at position 0, such that the gate 139 is centrally positioned at the bottom of the housing 101. As the size of air outlet vent 159 is equally distributed around the perimeter, the aerial vehicle can take off vertically, hover in air or land vertically depending on the power supplied to the impeller 105.

In FIG. 11A, the cranks of the front and back servomotors 161 are rotated while the left and right servo motors 161 are set at position 0, such that the gate is shift to the right, covering part of the air outlet 159 on the right. The unbalanced airflow 141 between the left and right sides causes a torque on the aerial vehicle causing it to roll clockwise as shown in FIG. 11B. The arrow shows the new direction of thrust being diagonally upward. As the vertical thrust vector is balanced with gravity, the net horizontal thrust vector results in accelerating the aerial vehicle to fly in the right direction.

FIG. 12 shows the cranks of the left and right servomotors 161 being rotated to shift the gate to the front, while the front and back servomotors 161 are set at position 0. In same logical way, this would cause the aerial vehicle to dive (rotate clockwise about the x axis) and to fly in the front direction.

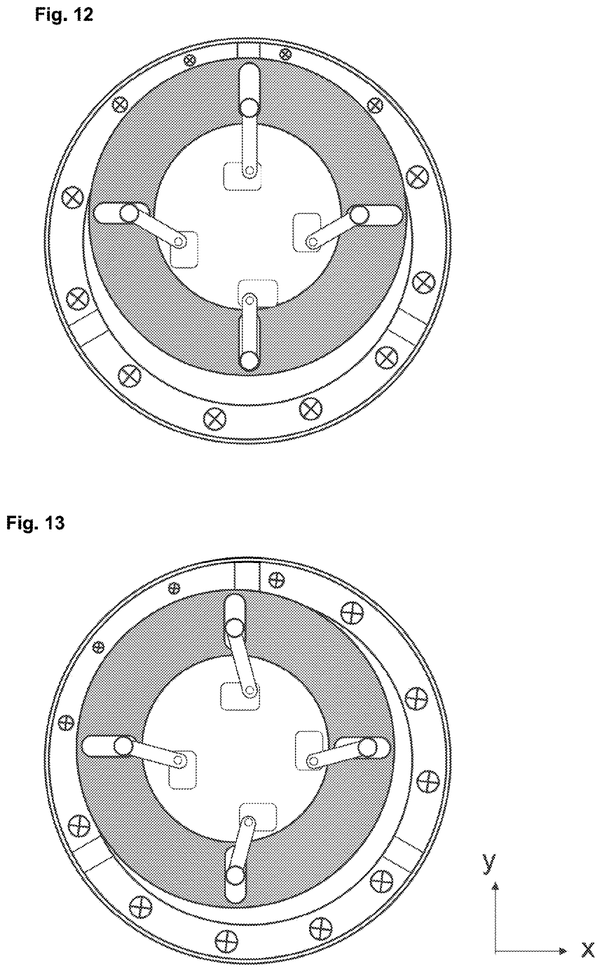

FIG. 13 shows the combined rotation of the cranks of all four servomotors 161 away from position 0, such that the gate 139 is shifted to the front left position, which would cause the aerial vehicle to rotate about a diagonal horizontal axis between x and y, causing to fly in the front left direction.

Thereby, the aerial vehicle is capable of rotating about any direction of horizontal axis and changing any thrust and flight direction by controlling the single gate 139 pivoted to 4 servomotors 161 in this embodiment. These servomotors 161 may be configured for manual control of direction and may also be controlled by gyroscopes to maintain flight stability.

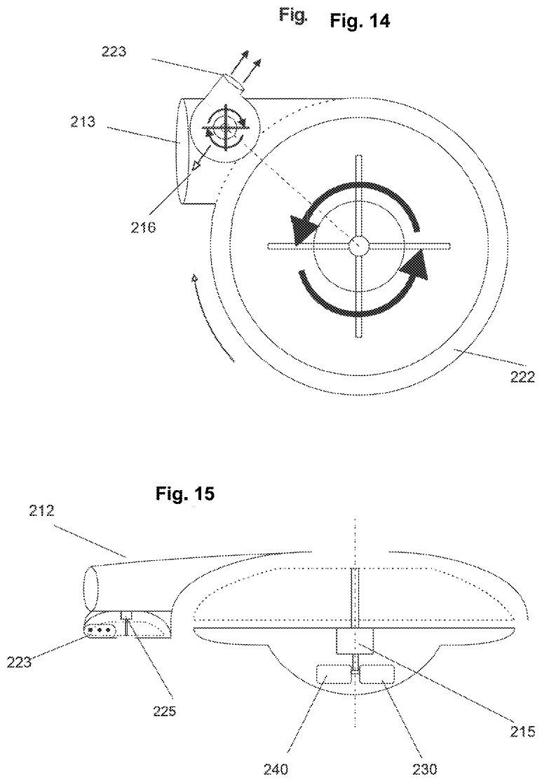

FIG. 14 shows another embodiment of the vehicle 200 which includes a main centrifugal fan propulsion system in the middle 210 and a relatively smaller centrifugal fan propulsion system 220 mounted proximal to the perimeter of the housing of the main centrifugal fan.

In this embodiment, the vehicle 200 comprises a main housing 211 supporting a first centrifugal fan 210 substantially axially positioned within the housing 211, the housing 211 comprising a perimeter and including a plurality of air channels to direct air from the first centrifugal fan 210 to one or more outlet vents at or proximal to the perimeter, a housing nozzle 212 extending from the perimeter of the main housing 211 and defining a rearward outlet vent 213, and a second centrifugal fan 220 mounted to the housing nozzle 212 and adapted to counteract a torque of the first centrifugal fan 210 on the vehicle 200.

The second centrifugal fan 220 is positioned such that air flow through the outlet of the fan is oriented tangentially to the first centrifugal fan housing 211 such that the thrust direction of the second centrifugal fan 220 can counteract the torque of the first centrifugal fan 210 on the vehicle 200.

The thrust from the second centrifugal fan 220 can counteract the reaction torque from the main centrifugal fan 210 by using a lever effect to enable a relatively low force acting at the distal end of the housing 211 from the centre of mass to cause relatively high torque. The secondary centrifugal fan 220 has a downward facing outlet 222 for vertical lift and a rearward facing outlet 223 for forward thrust. The second centrifugal fan 220 also has an outlet facing in a direction such that the opposite thrust direction can counteract the torque of the main centrifugal fan 210 acting on the vehicle 200. In other words, the thrust direction is orthogonal to a reference line from the hub of the main centrifugal fan to the hub of the second centrifugal fan as shown in FIG. 14. It is also orthogonal to the axis of rotation of the main centrifugal fan as shown in FIG. 15.

In FIGS. 14 and 15, the impellers of each of the first and second centrifugal fans is each run by a separate electric motor 215, 225 and powered and controlled by the flight controller 230 and battery 240 within the flying vehicle 200.

FIG. 15 shows a side sectional view of the vehicle of FIG. 14.

The rearward facing outlet 223 of the second centrifugal fan causes a thrust direction as shown and thereby a torque on the vehicle in a counterclockwise direction, mitigating part of the clockwise reaction torque from the main centrifugal fan 220.

In addition, the reaction torque from the clockwise rotating second centrifugal fan 220 also partially mitigates the reaction torque from the counter-clockwise rotating main centrifugal fan 210 as they spin in opposite direction (similar to how drones control yaw). These combined effects of using thrust and reaction torque of the impeller of the second centrifugal fan 220 to counteract the reaction torque of the main impeller improves the efficiency of and gives the advantages of using a centrifugal fan propulsion system for the second centrifugal fan 220, whereas conventional rotary wing helicopters can only rely on thrust to counteract torque as any secondary rotor does not spin in the same rotational plane as the main rotor.

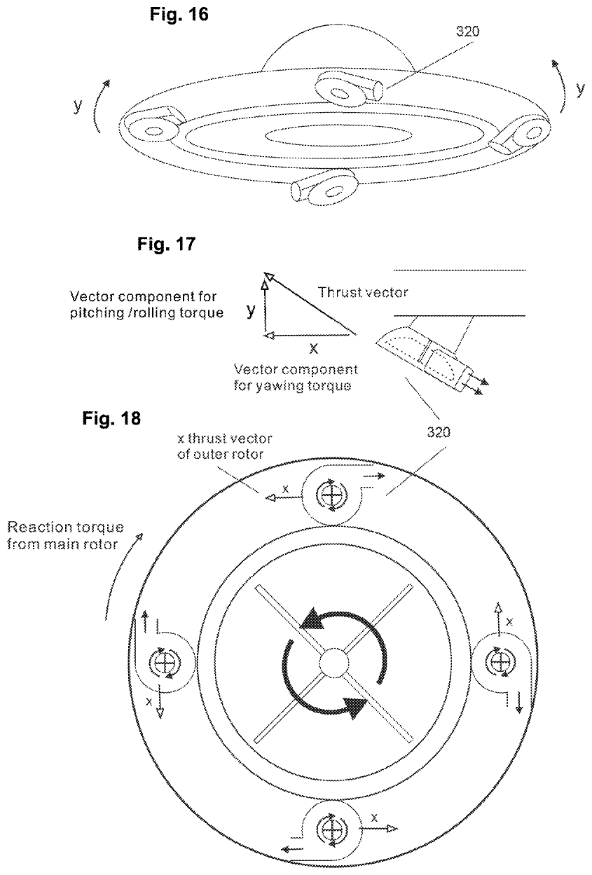

FIGS. 16 to 18 illustrate another embodiment of the vehicle 300. FIG. 16 shows a vehicle 300 comprising a housing 330 supporting a primary centrifugal fan 310 substantially axially positioned within the housing 330, the housing 330 comprising a perimeter and including a plurality of air channels to direct air from the primary centrifugal fan 310 to one or more outlet vents at or proximal to the perimeter, a plurality of secondary fans 320 mounted to an outer surface of the housing 330 and adapted to counteract a torque of the primary centrifugal fan 310 on the vehicle 300, in use.

Each secondary fan 320 is smaller than the primary centrifugal fan 310. There is provided a plurality of secondary fan housings 321 for supporting the secondary fans axially within the secondary fan housing 321, the secondary fan housing having a nozzle 322 defining an outlet.

With the primary centrifugal fan 310 and each of secondary fan 320 run by individual electric motor, the outlet airflow of each secondary fan 320 is adapted to counteract the pitching/rolling and yawing torque caused by the primary centrifugal fan 310.

The illustrated embodiment of the vehicle 300 includes multiple outer smaller secondary centrifugal fan propulsion systems 320 surrounding a larger primary centrifugal fan propulsion system 310. The secondary centrifugal fans 320 are preferably mounted symmetrically with equally distributed distance right below or around the perimeter of the housing of the main centrifugal fan 310.

Each secondary centrifugal fan 320 is preferably mounted at an angle to the plane of rotation of the primary centrifugal fan 310 with the rearward outlet positioned diagonally as shown in FIG. 17. This positions the thrust vector of each secondary centrifugal fan 320 with X component for yawing torque, and Y component for pitching or rolling torque as shown in FIG. 17. With the direction of thrust of the secondary centrifugal fans 320 as shown in FIG. 18, the X component thrust vector of each secondary centrifugal fan 320 combines for a larger counterclockwise yawing torque to counteract the reaction torque from the main centrifugal fan 310. The Y thrust vector component of each secondary centrifugal fan 320 cause pitching or rolling torque about the central point of the vehicle 300.

For vertical take-off and landing mode, all secondary centrifugal fans 310 are running with same speed such that Y thrust vector component of the secondary centrifugal fan 320 on the left side cause a clockwise pitching torque. The Y thrust vector component of the secondary centrifugal fan 320 on the right side causes a counterclockwise pitching torque as shown in FIG. 16, so the net pitching torque is zero and would result in a lifting force. This also applies for the other pair of outer rotors. Thereby the aerial vehicle 300 can be balanced horizontally during take-off or landing.

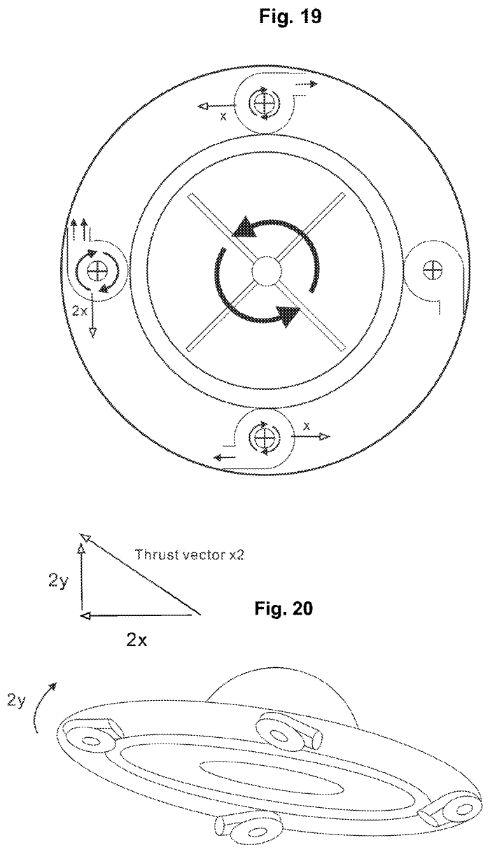

To perform pitching and rolling, at least one secondary centrifugal fan 320 is powered up to run at a higher RPM relative to other rotors. At the same time, the secondary centrifugal fan 320 on the opposite end is powered down to run at a lower RPM or stopped. This results in net clockwise pitching torque of vector 2Y and cause the flyer to pitch as shown in FIG. 20. The total yawing torque before the change in power is given by the sum of the x thrust vector of each of the four outer rotors, which is 4x as shown in FIG. 18. After changing the secondary centrifugal fan speed as shown in FIG. 19, the total yawing is given by 2x+x+x=4x. Therefore, the vehicle 300 can pitch or roll without causing adverse yaw.

It is also possible to accelerate adjacent secondary centrifugal fans 320 and decelerate 2 opposite secondary centrifugal fans 320 in a similar way as conventional drones to perform pitching or rolling for greater torque. Although it is more preferably to have at least 4 secondary centrifugal fans for better manoeuvrability, it is also understandable that using a minimum of 3 centrifugal fans 320 is possible to perform pitching and rolling. This can be achieved by increasing RPM for one secondary centrifugal fan 320 and decreasing RPM for the other two centrifugal fans 320 by an amount that can cause the total yawing torque to be as desired.

Overall, this embodiment has combined the advantage of higher propulsion efficiency and gyroscopic stability from the large centrifugal fan 310, as well as better manoeuvrability and stability from using at least 3 secondary centrifugal fans 320 to what becomes a safer, highly efficient, manoeuvrable and stable vehicle or unmanned aerial vehicle 300.

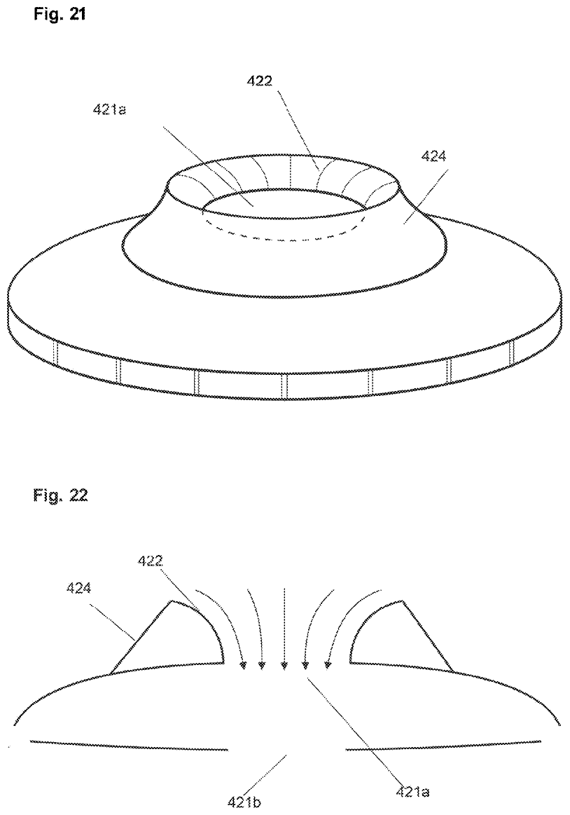

The centrifugal fan propulsion system of any of the above-mentioned or envisaged embodiments comprises at least one air inlet 420 at about the axis of rotation of the impeller of the centrifugal fan. The inlet 420 is usually located in the upper centred position of the main housing 411 as shown in FIG. 21. Alternatively, the main centrifugal fan housing 411 may have upper and lower centric inlet holes 421a, 421b as shown in FIG. 22, so that air can enter directly through at least one inlet facing towards the direction of flight regardless of the pitched angle of the aerial vehicle.

These embodiments include an upper inlet 420 with a curved conical duct 422 to improve efficiency through reduced air turbulence and increased lift. As shown in FIG. 22, the duct 422 with curved conical shape helps to guide the air streams to align in same direction by the stage entering the inlet hole, minimizing air turbulence. Secondly, the air stream that flows along the conical curved edge of the duct provides extra lift for the vehicle similar to airfoil. The embodiment can further comprise an angled duct shield 424 surrounding the inlet duct to provide aerodynamic property of the flyer.

### Advantages

Typically, the size of prior art systems is limited due to the design requirement of other parts of the aircrafts such as fuselage, front and tail wings to keep it stable in air. The present embodiments distinguish from prior art of centrifugal fan propulsion aircraft in that they use the centrifugal fan housing as the main body of the aircraft.

Using the round housing of the centrifugal fan propulsion system as the main body of the aircraft gives several technical advantages. Firstly, it enables the diameter of the impeller to be as long as possible relative to size of the flyer for maximising propulsion efficiency and gyroscopic stability. Secondly, it provides manoeuvrability advantage by having the downward facing outlet with annular shape at the furthest points in equal distance from the centre of mass for all angles, maximising and regulating the pitching torque for any axis of rotation of the centrifugal fan. Thirdly, there is no need for additional material (which adds extra weight to the main body) such as the fuselage, front and back wings. The curved top of conical or dome shaped housing can provide lift from incoming air during horizontal flight. Fourthly, the air streaming out through the backward facing outlet would increase the drag on the rear body of prior art, particularly the tail wings. Such advantages are particularly important for the use of the vehicle as an unmanned aerial vehicle.

Many modifications of the above embodiments will be apparent to those skilled in the art without departing from the scope of the present invention.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1.-20. (canceled)

21. An aerial vehicle, comprising:
a housing supporting at least one impeller substantially axially positioned within the housing, the housing comprising:
a perimeter and including one or more air channels to direct air from the at least one impeller to outlet vents at or proximal to the perimeter;
one or more gates proximal to the one or more air channels for opening the channels to allow airflow therethrough and for closing the channels to restrict airflow; and
at least one motor configured to operate the one or more gates.

22. The aerial vehicle of claim 21, wherein the housing has a substantially conical or spherical shape.

23. The aerial vehicle of claim 22, further comprising a second impeller.

24. The aerial vehicle of claim 23, wherein the second impeller is supported by the housing, and wherein the housing further comprises one or more second air channels and second gates proximal to the second impeller.

25. The aerial vehicle of claim 21, wherein a gate of the one or more gates is configured to slide open and closed.

26. The aerial vehicle of claim 21 wherein a gate of the one or more gates is a channel separator configured to pivot.

27. An aerial vehicle, comprising:
a main housing supporting a first centrifugal fan substantially axially positioned within the main housing, the main housing comprising a perimeter and including a plurality of air channels to direct air from the first centrifugal fan to one or more outlet vents at or proximal to the perimeter;
a housing nozzle extending from the perimeter of the main housing and defining a rearward outlet vent; and
a second centrifugal fan mounted to the housing nozzle and adapted to counteract a torque of the first centrifugal fan on the aerial vehicle.

28. An aerial vehicle, comprising:
a housing supporting a primary centrifugal fan substantially axially positioned within the housing, the housing comprising a perimeter and including one or more air channels to direct air from the primary centrifugal fan to one or more outlet vents at or proximal to the perimeter,
a plurality of secondary fans mounted to an outer surface of the housing and adapted to counteract a torque of the primary centrifugal fan on the aerial vehicle, in use.

29. The aerial vehicle of claim 28, wherein each secondary fan of the plurality of secondary fans is smaller than the primary centrifugal fan.

30. The aerial vehicle of claim 29, wherein the vehicle further comprises a plurality of secondary fan housings for supporting the secondary fans axially within the secondary fan housing, the secondary fan housings having a nozzle defining an outlet.

31. The aerial vehicle of claim 28, wherein a secondary fan of the plurality of secondary fans is a centrifugal fan.

32. The aerial vehicle of claim 28, wherein outlet airflow of each secondary fan is adapted to counteract the pitching/rolling of the aerial vehicle.

33. The aerial vehicle of claim 28, wherein outlet airflow of each secondary fan is configured to counteract torque caused by the primary centrifugal fan.

34. The aerial vehicle of claim 28, wherein the housing one or more gates proximal to the air channels for opening to allow airflow therethrough and for closing the air channels to restrict airflow and at least one motor configured to operate the one or more gates.

35. The aerial vehicle of claim 28, wherein each of the secondary fans is mounted proximal to the perimeter of and equidistantly along the outer surface of the housing of the primary centrifugal fan.

36. An aerial vehicle, comprising:
a housing supporting at least one impeller substantially axially positioned within the housing;
an inlet at a top of the housing and an outlet at a bottom of the housing together defining an air channel;
at least one gate operably connected to the impeller and located proximal to the outlet;
at least one motor operably connected to the at least one gate and configured to move the at least one gate, wherein horizontal movement of the at least one gate changes the shape of the air channel, causing tilting of the aerial vehicle in use.

37. The aerial vehicle of claim 36, wherein the housing has a cylindrical or a conical shape.

38. The aerial vehicle of claim 36, wherein the at least one motor is connected to the at least one gate via a slot and pin arrangement.

39. The aerial vehicle of claim 36, further comprising at least one additional motor operably connected to the at least one impeller or to a centrifugal fan.

40. The aerial vehicle of claim 36, wherein the aerial vehicle is an unmanned aerial vehicle.
